(19) United States
(12) Patent Application Publication
(10) Pub. No.: US 2008/0050839 A1
(43) Pub. Date: Feb. 28, 2008

(54) Apparatus and method for detecting lung cancer using exhaled breath

(76) Inventors: Kenneth S. Suslick, Champaign, IL (US); William B. McNamara III, Urbana, IL (US)

Correspondence Address: Jane Massey Licata;Licata & Tyrrell P.C., 66 E. Main Street, Marlton, NJ, 08053, US

(21) Appl. No.: 11/768,670

(22) Filed: Jun. 26, 2007

Related U.S. Application Data
(63) Continuation-in-part of application No. 11/058,497, filed on Feb. 15, 2005, now abandoned.
Application No. 11/058,497 is a continuation-in-part of application No. 10/279,788, filed on Oct. 24, 2002, now Pat. No. 7,261,857.
Application No. 10/279,788 is a continuation-in-part of application No. 09/705,329, filed on Nov. 3, 2000, now Pat. No. 6,495,102.
Application No. 09/705,329 is a continuation-in-part of application No. 09/532,125, filed on Mar. 21, 2000, now Pat. No. 6,368,558.

(51) Int. Cl. G01J 3/46

(52) U.S. Cl. 436/164; 422/85

(57) ABSTRACT

The present invention is an apparatus and method for detecting lung cancer. The apparatus is composed of a breath capture device including a colorimetric sensor array with a plurality of chemoresponsive dyes deposited thereon in a predetermined pattern combination, wherein the dyes produce a distinct and direct spectral, transmission or reflectance response in the presence of analytes in the exhaled breath of lung cancer patients. Air flow, temperature regulation, and visual imaging components of the instant apparatus are also provided.

### INTRODUCTION

This application is a continuation-in-part application of U.S. patent application Ser. No. 11/058,497, filed Feb. 15, 2005, which is a continuation-in-part application of U.S. patent application Ser. No. 10/279,788, filed Oct. 24, 2002, which is a continuation-in-part application of U.S. patent application Ser. No. 09/705,329, filed Nov. 3, 2000, now U.S. Pat. No. 6,495,102, which is a continuation-in-part application of U.S. patent application Ser. No. 09/532,125, filed Mar. 21, 2000, now U.S. Pat. No. 6,368,558, all of which are incorporated herein by reference in their entireties.

This invention was made in the course of research sponsored by the National Institutes of Health (Grant No. R01-HL25934). The U.S. government may have certain rights in this invention.

### BACKGROUND OF THE INVENTION

Lung cancer causes more than 150,000 deaths in the United States each year (Patz, et al. (2004) J. Clin. Oncol. 22:2202-2206). Diagnosis of lung cancer is problematic, particularly in the early stages when it manifests no outward symptoms. When symptoms do occur they are often general and do not lend themselves to easy diagnosis as cancer (Ferguson (1990) Hematol. Oncol. Clin. North Am. 4:1053-1068). When a correct diagnosis for lung cancer is made, therefore, the cancer is often at an advanced stage, significantly reducing the likelihood of successful treatment (Jemal, et al. (2006) CA Cancer J. Clin. 56:106-130).

Current techniques for the diagnosis of lung cancer rely on costly equipment which have the potential for complications. Lung imaging techniques are advancing rapidly but tend to reveal multiple features, such as nodules, that can not unequivocally be diagnosed as cancer, thus requiring repeated and costly testing (Fischbach, et al. (2003) Eur. Radiol. 13:2378-2383). An accurate, inexpensive, and non-invasive test for lung cancer, particularly early-stage lung cancer, could decrease the mortality and morbidity currently associated with lung cancer.

Toward that end, exhaled breath has been examined to determine if there is any correlation between exhaled analytes and lung cancer status. There have been several reports describing select analytes present on the breath exhaled by lung cancer-positive subjects that are absent from, or appear at lesser concentrations in, breath exhaled by subjects without lung cancer. (Gordon, et al. (1985) Clin. Chem. 31:1278-1282; O'Neill, et al. (1988) Clin. Chem. 34:1613-1618; Preti, et al. (1988) J. Chromatogr. 432:1-11; Phillips, et al. (1999) Lancet 353:1930-1933; Phillips, et al. (2003) Chest 123:2115-2123; Corradi, et al. (2003) G. Ital. Med. Lav. Ergon. 25S3:59-60; Poli, et al. (2005) Respir. Res. 6:71). It has been suggested that these analytes might serve as biomarkers for the presence of lung cancer. Many other disease states are associated with distinctive exhaled scents, and the detection of exhaled biomarkers represents a fundamental window on the internal functioning of the body (Pavlou, et al. (2000) Biosensors & Bioelectronics 15:333-342).

The list of biomarkers reported for lung cancer can not be considered definitive or exhaustive, however, as the techniques used in those studies inherently favor the detection of certain analytes relative to others. As such, there are likely multiple exhaled biomarkers for lung cancer that have yet to be discovered and documented using traditional analytical techniques, but which might be detected, even if not unambiguously identified, by other techniques such as array-based vapor sensing.

Array-based vapor sensing is an approach for detecting chemically diverse analytes. Incorporating cross-responsive sensor elements as well as specific receptors for specific analytes, these systems produce composite responses unique to an odorant in a fashion similar to the mammalian olfactory system (Stetter & Pensrose, Eds. (2001) Artificial Chemical Sensing: Olfaction and the Electronic Nose, Electrochem. Soc., NJ; Gardner & Bartlett (1999) Electronic Noses: Principles and Applications, Oxford University Press, NY; Persaud & Dodd (1982) Nature 299:352-355; Albert, et al. (2000) Chem. Rev. 100:2595-2626; Lewis (2004) Acc. Chem. Res. 37:663-672; James, et al. (2005) Microchim. Acta 149:1-17). In such arrays, one receptor can respond to many analytes and many receptors can respond to any given analyte. A distinct pattern of responses produced by the sensor array can provide a characteristic fingerprint for each analyte. Using such systems, volatile organic compounds have been detected and differentiated (Rakow & Suslick (2000) Nature 406:710-713; Suslick & Rakow (2001) Artificial Chemical Sensing: Olfaction and the Electronic Nose, Stetter & Penrose, Eds., Electrochem. Soc.: Pennington, N.J., pp. 8-14; Suslick, et al. (2004) Tetrahedron 60:11133-11138; Suslick (2004) MRS Bulletin 29:720-725; Rakow, et al. (2005) Angew. Chem. Int. Ed. 44:4528-4532; Zhang & Suslick (2005) J. Am. Chem. Soc. 127:11548-11549).

Array technologies of the prior art generally rely on multiple, cross-reactive sensors based primarily on changes in properties (e.g., mass, volume, conductivity) of some set of polymers or on electrochemical oxidations at a set of heated metal oxides. Specific examples include conductive polymers and polymer composites (Gallazzi, et al. (2003) Sens. Actuators B 88:178-189; Guadarrana, et al. (2002) Anal. Chim. Acta 455:41-47; Garcia-Guzman, et al. (2003) Sens. Actuators B 95:232-243; Burl, et al. (2001) Sens. Actuators B 72:149-159; Wang, et al. (2003) Chem. Mater. 15:375-377; Hopkins & Lewis (2001) Anal. Chem. 73:884-892; Feller & Grohens (2004) Sens. Actuators B 97:231-242; Ferreira, et al. (2003) Anal. Chem. 75:953-955; Riul, et al. (2004) Sens. Actuators B 98:77-82; Sotzing, et al. (2000) Anal. Chem. 72:3181-3190; Segal, et al. (2005) Sens. Actuators B 104:140-150; Burl, et al. (2002) Sens. Actuators B 87:130-149; Severin, et al. (2000) Anal. Chem. 72:658-668; Freund & Lewis (1995) Proc. Natl. Acad. Sci. USA 92:2652-2656; Gardner, et al. (1995) Sens. Actuators B 26:135-139; Bartlett, et al. (1989) Sens. Actuators B 19:125-140; Shurmer, et al. (1990) Sens. Actuators B 1:256-260; Lonergan, et al. (1996) Chem. Mater. 8:2298-2312), polymers impregnated with a solvatochromic dye or fluorophore (Chen & Chang (2004) Anal. Chem. 76:3727-3734; Hsieh & Zellers (2004) Anal. Chem. 76:1885-1895; Li, et al. (2003) Sens. Actuators B 92:73-80; Albert & Walt (2003) Anal. Chem. 75:4161-4167; Epstein, et al. (2002) Anal. Chem. 74:1836-1840; Albert, et al. (2001) Anal. Chem. 73:2501-2508; Stitzel, et al. (2001) Anal. Chem. 73:5266-5271; Albert & Walt (2000) Anal. Chem. 72:1947-1955; Dickinson, et al. (1996) Nature 382:697-700; Dickinson, et al. (1996) Anal. Chem. 68:2192-2198; Dickinson, et al. (1999) Anal. Chem. 71:2192-2198), mixed metal oxide sensors (Gardner & Bartlett (1992) Sensors and Sensory Systems for an Electronic Nose, Kluwer Academic Publishers, Dordrecht; Zampolli, et al. (2004) Sens. Actuators B 101:39-46; Tomchenko, et al. (2003) Sens. Actuators B 93:126-134; Nicolas & Romain (2004) Sens. Actuators B 99:384-392; Marquis & Vetelino (2001) Sens. Actuators B 77:100-110; Ehrmann, et al. (2000) Sens. Actuators B 65:247-249; Getino, et al. (1999) Sens. Actuators B 59:249-254; Heilig, et al. (1997) Sens. Actuators B 43:45-51; Gardner, et al. (1991) Sens. Actuators B 4:117-121; Gardner, et al. (1992) Sens. Actuators B 6:71-75; Corcoran, et al. (1993) Sens. Actuator B 15:32-37; Gardner, et al. (1995) Sens. Actuators B 26:135-139), and polymer-coated surface acoustic wave (SAW) devices (Grate (2000) Chem. Rev. 100:2627-2648; Hsieh & Zellers (2004) Anal. Chem. 76:1885-1895; Grate, et al. (2003) Anal. Chim. Acta 490:169-184; Penza & Cassano (2003) Sens. Actuators B 89:269-284; Levit, et al. (2002) Sens. Actutors B 82:241-249; Grate, et al. (2001) Anal. Chem. 73:5247-5259; Hierlemann, et al. (2001) Anal. Chem. 73:3458-3466; Grate, et al. (2000) Anal. Chem. 72:2861-2868; Ballantine, et al. (1986) Anal. Chem. 58:3058-3066; Rose-Pehrsson, et al. (1988) Anal. Chem. 60:2801-2811; Patrash & Zellers (1993) Anal. Chem. 65:2055-2066). However, the sensors disclosed in these prior art references do not provide as broad a diversity of interactions with analytes as is desirable, but rather tend to exploit the weakest and least specific of intermolecular interactions, primarily van der Waals and physical adsorption interactions between sensor and analyte. As such, both sensitivity for detection of compounds at low concentrations relative to their vapor pressures and selectivity for discrimination between compounds is compromised with these prior art sensors.

Cross-responsive sensors have seen limited application to the diagnosis of lung cancer via exhaled analytes. In particular, quartz microbalance (Di Natale, et al. (2003) Biosens. Bioelectron. 18:1209-1218) and conducting polymer technologies (Machado, et al. (2005) Am. J. Respir. Crit. Care Med. 171:1286-91) have been used in attempts to detect lung cancer based on analysis of exhaled analytes. The first system, however, employed only porphyrinic sensors and the latter employed only polymeric sensors, thus limiting the range of exhaled analytes that could be detected by each of these array sensors.

Needed is a non-invasive, cost-efficient, sensitive, and selective method and apparatus for the rapid diagnosis of lung cancer; a system that is capable of providing real-time results in the context of a single visit to a physician's office. The present invention meets this long-felt need.

### SUMMARY OF THE INVENTION

The present invention is an apparatus for detecting lung cancer. The apparatus is composed of a breath capture device including at least one colorimetric sensor array having a plurality of chemoresponsive dyes deposited thereon in a predetermined pattern combination, wherein at least one of the chemoresponsive dyes is a selected Lewis acid/base dye and wherein, in response to lung cancer analytes in exhaled breath, a distinct and direct spectral, transmission or reflectance response is produced by the dyes. In one embodiment, the apparatus includes an air flow component to pass a predetermined amount of exhaled breath over the colorimetric sensor array. In another embodiment, the apparatus includes a component for maintaining the apparatus at physiological temperature. In yet a further embodiment, the apparatus of the present invention is a component of a system which includes a visual imaging component. A method for detecting lung cancer using the apparatus of the present invention is also provided.

### BRIEF DESCRIPTION OF THE DRAWINGS

FIG. 1 is a schematic of the instant apparatus for detecting lung cancer.

FIG. 2 is a schematic of the instant apparatus which employs an air flow component.

FIG. 3 is a schematic of the instant apparatus housed in an enclosure.

FIG. 4 is a schematic depicting a system containing the instant apparatus in combination with a visual imaging component and a computer.

FIG. 5 is a schematic depicting a system containing the instant apparatus in combination with optimized visual imaging components.

### DETAILED DESCRIPTION OF THE INVENTION

The instant invention relates the use of chemoresponsive dyes for detecting the presence of lung cancer based on gases exhaled by subjects with lung cancer. As used herein, chemoresponsive dyes are dyes that change color, in either reflected or absorbed light, upon changes in their chemical environment.

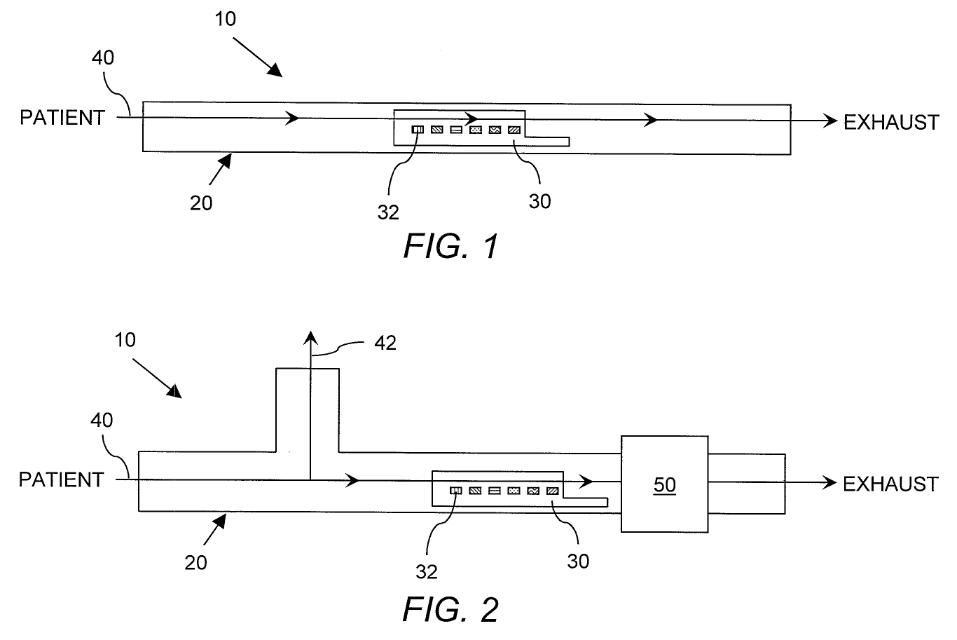

With reference to FIG. 1, an apparatus 10 of the present invention is a breath capture device 20 including of a colorimetric sensor array 30 (e.g., as part of a cartridge) having deposited thereon a plurality of chemoresponsive dyes 32. The breath capture device 20 can be any suitable structure that facilitates the passage of the exhaled breath 40 over the colorimetric sensor array 30. For example, the breath capture device can be a mask or conical-shaped structure into which the subject exhales a breath. Alternatively, the breath capture device can be a tube, e.g., similar to an alcohol breathalyzer, or container which can capture volatile components in breath and optionally remove water vapor from the breath to facilitate detection of exhaled analytes. See, for example, U.S. Pat. Nos. 4,749,553; 5,458,853; and 6,726,637, which disclose breath capture devices suitable for use in accordance with the apparatus of the instant invention. Desirably, the instant apparatus is made of a medical grade plastic capable of being sterilized and is optionally disposable.

When the subject exhales one or several breaths into the breath capture device, the breath capture device conducts the breath sample into contact with a colorimetric sensor array. In the embodiment depicted in FIG. 2, a downstream air flow component 50 is employed to generate a controllable and predetermined flow of exhaled breath 40 over the colorimetric sensor array 30. Air flow component 50 can be, e.g., a conventional air pump or other suitable device. In accordance with this embodiment, the excess exhaled breath 42 is directed away from the colorimetric sensor array 30 as exhaust.

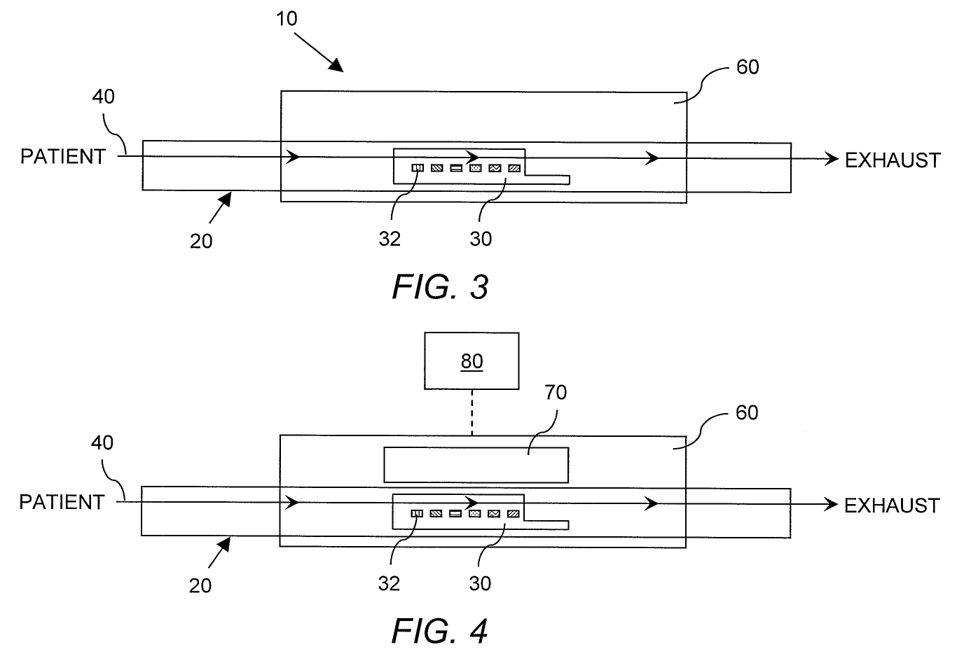

In some embodiments, the apparatus can be used at ambient temperature. In other embodiments, the apparatus is used within several degrees of physiological temperature (i.e., 37° C.) for optimal detection of exhaled gases. Accordingly, as depicted in FIG. 3, the breath capture device 20 containing at least one colorimetric sensor array 30 can be housed in an enclosure 60, which in certain embodiments is light-tight and in other embodiments is held at physiological temperature.

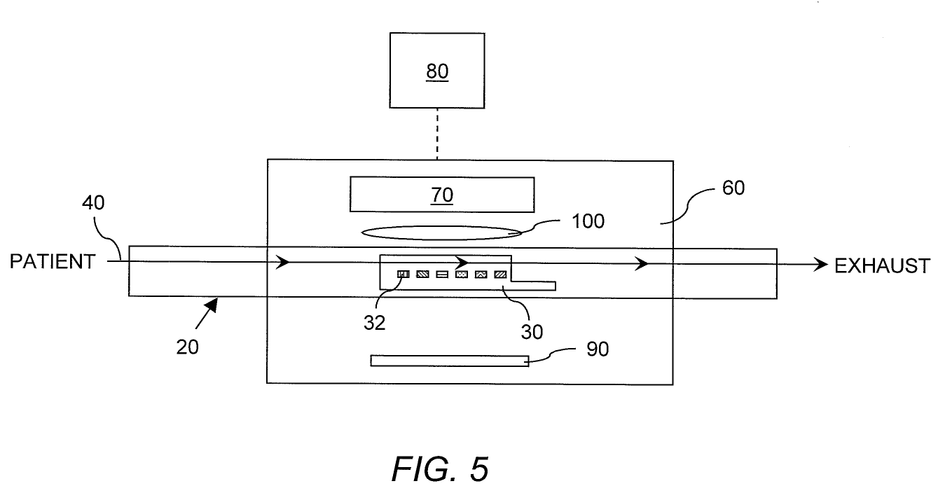

Operation and readout of the instant apparatus can be performed manually, or alternatively, can be controlled and visualized automatically. Accordingly, as depicted in FIGS. 4 and 5, the instant apparatus can be a component of a system. In some embodiments, the system of the present invention includes a visual imaging or image capture component 70 (e.g., a scanner or camera such as a CCD or CMOS device) within or external to enclosure 60, for detecting responses of dyes 32 to analytes in exhaled breath 40. The system can also include a computer or dedicated device 80, e.g., with an operating system, logic, display, and/or data analysis capabilities. In use, the subject/patient exhales breath 40 into a breath capture device 20 so that the exhaled breath 40 comes in direct contact with dyes 32 deposited on colorimetric sensor array 30. Subsequently, visual imaging component 70 captures the distinct and direct spectral, transmission or reflectance response produced by the dyes 32 in response to analytes in exhaled breath 40. The image is then analyzed and/or displayed by computer 80.

To facilitate detection of signals generated by the colorimetric sensor array upon exposure to the exhaled breath, the system of the present invention can further contain optimized visual imaging components. For example, as shown in FIG. 5, the system can further include an illumination source 90 and lens 100 in combination with visual imaging component 70.

As indicated, the apparatus can be operated manually or by software or an operating system that either resides on a computer or which is embedded in a dedicated device. This software can register the time at which exhaled breath sampling commences, control the sampling pump, control the visual imaging component and image processing, perform data analysis on the color changes occurring during exposure to exhaled breath, and provide output such as presence or absence of lung cancer. If the colorimetric sensor array is inspected automatically, the computer can facilitate three main functions: breath capture or sampling, image acquisition or capture, and image processing. Prior to and during exposure of the colorimetric sensor array to exhaled breath, the colorimetric sensor array is monitored by the visual imaging component for image acquisition. Images of the colorimetric sensor array can be captured at regular predetermined intervals and subsequently analyzed using well-known image processing techniques and algorithms to determine the presence or absence of lung cancer and output the diagnosis. Such software or algorithms to achieve these tasks can be readily obtained or generated by the skilled artisan.

The colorimetric sensor array of the present invention is a substrate with a plurality of chemoresponsive dyes deposited thereon in a predetermined pattern combination. The substrate for retaining the chemoresponsive dyes can be a surface of a container, e.g., a cartridge or can be a separate substrate within a container or cartridge. The substrate can be composed of any suitable material or materials, including but not limited to, chromatography plates, paper, filter papers, porous membranes, or properly formed polymers, glasses, or metals. However, particular embodiments embrace the use of a hydrophobic substrate. Dyes can be covalently or non-covalently affixed in or on a colorimetric sensor array substrate by direct deposition, including, but not limited to, airbrushing, ink-jet printing, screen printing, stamping, micropipette spotting, or nanoliter dispensing. In particular embodiments, the colorimetric sensor array is retained in or on a cartridge to facilitate, e.g., sterilization, disposal, or exchange of arrays in the instant apparatus.

In general, the detection and identification of analytes is fundamentally based upon supramolecular chemistry and intrinsically relies on the interactions between molecules, atoms, and ions. The instant invention advantageously employs chemoresponsive dyes capable of strong interactions, e.g., greater than 10 kJ/mol or preferably greater than 25 kJ/mol, with many analytes present in breath exhaled by lung cancer subjects.

To achieve such strong interactions and further provide a means for detection, many of the chemoresponsive dyes employed in the instant invention each contain a center to interact strongly with analytes, and each interaction center is strongly coupled to an intense chromophore. As used herein, chemoresponsive dyes are dyes that change color, in either reflected or absorbed light, upon changes in their chemical environment.

Chemoresponsive dyes which provide the desired interactions and chromophores include Lewis acid/base dyes (i.e., metal ion containing dyes such as metalloporphyrins), Brønsted acidic or basic dyes (i.e., pH indicators), and dyes with large permanent dipoles (i.e., zwitterionic solvatochromic dyes). Example 2 provides examples of chemoresponsive dyes and the respective analytes which can be detected.

For recognition of analytes with Lewis acid/base capabilities, the use of porphyrins and their metal complexes is desirable. Metalloporphyrins are ideal for the detection of metal-ligating vapors because of their open coordination sites for axial ligation, their large spectroscopic shifts upon ligand binding, their intense coloration, and their ability to provide ligand differentiation based on metal-selective coordination. Furthermore, metalloporphyrins are cross-responsive dyes, showing responses to a large variety of different magnitudes and kinetics of color change.

A Lewis acid/base dye is defined as a dye which has been identified for its ability to interact with analytes by acceptor-donor sharing of a pair of electrons from the analyte. This results in a change in color and/or intensity of color that indicates the presence of the analyte. Lewis acid/base dyes include metal ion-containing or three-coordinate boron-containing dyes. Exemplary Lewis acid/base dyes include, but are not limited to, metal ion-containing porphyrins (i.e., metalloporphyrins), salen complexes, chlorins, bispocket porphyrins, and phthalocyanines.

A Brønsted acid dye of the present invention is a pH indicator dye which changes color in response to changes in the proton (Brønsted) acidity or basicity of the environment. For example, Brønsted acid dyes are, in general, non-metalated dyes that are proton donors which can change color by donating a proton to a Brønsted base (i.e., a proton acceptor). Brønsted acid dyes include, but are not limited to, protonated, but non-metalated, porphyrins, chlorins, bispocket porphyrins, phthalocyanines, and related polypyrrolic dyes. Polypyrrolic dyes, when protonated, are in general pH-sensitive dyes (i.e., pH indicator or acid-base indicator dyes that change color upon exposure to acids or bases) In one embodiment, a Brønsted acid dye is a non-metalated porphyrin such as 5,10,15,20-tetrakis(2′,6′-bis(dimethyl-t-butylsiloxyl)phenyl)porphyrin dication [H₄Si₈PP]⁺²; 5,10,15,20-Tetraphenyl-21H,23H-porphine [H₂TPP]; or 5,10,15,20-Tetraphenylporphine dication [H₄TPP]⁺². In another embodiment of the instant invention, a selected Brønsted dye is an indicator dye including, but not limited to, Bromocresol Purple, Cresol Red, Congo Red, Thymol Blue, Bromocresol Green, Bromothymol Blue, Methyl Red, Nitrazine Yellow, Phenol Red, Bromophenol Red, and Bromophenol Blue. As will be appreciated by the skilled artisan, the Brønsted acids disclosed herein may also be considered Brønsted bases under particular pH conditions. Likewise, a non-metalated, non-protonated, free base form of a bispocket porphyrin may also be considered a Brønsted base. However, these dye forms are also expressly considered to be within the scope of the dyes disclosed herein.

Solvatochromic dyes change color in response to changes in the general polarity of their environment, primarily through strong dipole-dipole and dispersion interactions. Particular examples of suitable solvatochromic dyes include, but are not limited to Reichardt's dyes, 4-hydroxystyryl-pyridinium dye, 4-methoxycarbonyl-1-ethylpyridinium iodide, and 2,6-diphenyl-4-(2,4,6-triphenyl-1-pyridinio)-phenolate.

The addition of at least one Brønsted acid dye to an array containing at least one metal ion-containing Lewis acid dye can improve the sensitivity of the array for particular analytes and increase the ability to discriminate between analytes. For example, a colorimetric sensor array similar to that of the present invention has been shown to detect volatile organic compounds and complex mixtures down to ppb levels (Rakow, et al. (2005) Angew. Chem. Int. Ed. 44:4528-4532). Further, the use of one or more metal ion-containing dyes in combination with one or more Brønsted acid dyes can advantageously create a signature indicative of the presence of a particular analyte. Thus, while some embodiments embrace the use of at least one Lewis acid and/or base dye, one Brønsted acidic and/or basic dye, or one zwitterionic solvatochromic dye, other embodiments of this invention embrace the use at least two different classes of dyes on the instant arrays. In one embodiment, the colorimetric sensor array contains at least one Lewis acid and/or base dye, one Brønsted acidic and/or basic dye, or one zwitterionic solvatochromic dye. In another embodiment, the colorimetric sensor array contains at least one Lewis acid and/or base dye and one Brønsted acidic and/or basic dye. In a further embodiment, the colorimetric sensor array contains at least one Lewis acid and/or base dye and one zwitterionic solvatochromic dye. In yet a further embodiment, the colorimetric sensor array contains at least one Brønsted acidic and/or basic dye and one zwitterionic solvatochromic dye. Still further embodiments embrace the use at least three different classes of dyes on the instant arrays, i.e., at least one Lewis acid and/or base dye, one Brønsted acidic and/or basic dye, and one zwitterionic solvatochromic dye.

To detect and distinguish a multitude of analytes, the instant colorimetric sensor array employs a plurality of chemoresponsive dyes. In accordance with the present invention, the plurality of dyes is deposited on the array substrate in a predetermined pattern combination. Alternatively stated, the dyes are arranged in a two-dimensional spatially-resolved configuration so that upon interaction with one or more analytes, a distinct color and intensity response of each dye creates a signature indicative of the one or more analytes. A plurality of chemoresponsive dyes encompasses 2, 3, 4, 5, 6, 7, 8, 9, 10, 15, 20, 25, 30, 35, 40, or 50 individual dyes. In particular embodiments, a plurality of chemoresponsive dyes is 2 or more, 5 or more, 10 or more, 15 or more, 20 or more, 25 or more, or 30 or more dyes. The chemoresponsive dyes can be deposited in predetermined pattern combinations of rows, columns, spirals, etc., and the plurality of chemoresponsive dyes of the instant apparatus can be present on one or more colorimetric sensor arrays in a container or cartridge.

The interference of atmospheric humidity on sensor performance is a problem with cross-responsive sensors of the prior art. The high concentration of water vapor in the environment and its large and changeable range makes the accurate detection of analytes at low concentration difficult with the prior art sensors. Water vapor ranges in the environment from <2000 to >20,000 parts per million volume (ppmv) and is substantially higher on exhaled breath. Thus, when detecting a few ppmv of an analyte, or even a few parts per billion volume (ppbv), even a very low level of interference from water is intolerable. Physisorption of molecules on surfaces is dominated by the relative hydrophobicity of the adsorbate and adsorbent. Therefore, a disadvantage of the cross-responsive sensor technology of the prior art is sensitivity to changes in humidity.

In contrast, the dyes of the instant colorimetric sensor array are generally but not exclusively selected from hydrophobic, water-insoluble dyes which are generally but not exclusively printed or otherwise deposited as non-aqueous, hydrophobic solutions onto hydrophobic substrates. As such, the instant colorimetric sensor array is essentially impervious to changes in relative humidity (RH). For example, a colorimetric sensor array exposed to water vapor from pure water (RH 100%) or to saturated salt solutions whose water vapor pressures ranged from 11% to 94% RH shows that the dyes in the calorimetric sensor array are unresponsive to water vapor. Similarly, the response to other analytes is not affected by the presence or absence of water vapor over this range. As such, particular embodiments of the instant colorimetric sensor arrays can be used directly in water for the sensing of dilute aqueous solutions of organic compounds (Zhang & Suslick (2005) vide supra). Therefore, in particular embodiments, chemoresponsive dyes of the instant invention are hydrophobic or water-insoluble. As used herein hydrophobic is used in the conventional sense to describe a compound which is incapable of dissolving in water.

Advantageously, the instant colorimetric sensor array probes the full range of intermolecular interactions to facilitate the detection of lung cancer analytes such as, e.g., amines, phosphines, sulfides, thiols, alcohols, etc., present on exhaled breath. Further, the colorimetric sensor array of the invention is sensitive and robust (i.e., stable to exposure to analytes or the environment). Desirably, this is achieved by employing disposable sensors, which are not integrated to the readout device, thus unlinking the opposing demands of sensitivity and robustness placed on the sensor.

The present invention is an improvement over the “optoelectronic nose” which is based on the colorimetric array detection using a chemically diverse range of chemically responsive dyes (Rakow & Suslick (2000) vide supra; Suslick & Rakow (2001) vide supra; Suslick, et al. (2004) vide supra; Suslick (2004) vide supra; Rakow, et al. (2005) vide supra; Zhang & Suslick (2005) vide supra; U.S. Pat. Nos. 6,368,558 and 6,495,102). In the instant invention, olfactory-like responses are converted to a visual output which can be readily detected and analyzed by digital imaging and pattern recognition techniques (Beebe, et al. (1998) Chemometrics: Practical Guide; J. Wiley & Sons, Inc.: New York; Haswell, Ed. (1992) Practical Guide to Chemometrics; Marcel Dekker, Inc.: New York).

In this regard, the apparatus of the instant invention can further be combined with a visual imaging component for monitoring the spectroscopic response, transmission response or reflectance response of the dyes on the colorimetric sensor array at one or more wavelengths in a spatially resolved fashion so that all of the spots in the colorimetric sensor array are individually imaged or addressed and the color of each spot is individually determined. For the purposes of the present invention, the terms color and colorimetric are intended to include wavelengths in the visible portion of the electromagnetic spectrum, as well as the invisible portion of the electromagnetic spectrum, e.g., infrared and ultraviolet. Color detection can be accomplished with an imaging spectrophotometer, a flatbed scanner, slide scanner, a video or CCD or CMOS digital camera, or a light source combined with a CCD or CMOS detector. Any still or video as well as analog or digital camera can be employed. Moreover, any imaging format can be used, e.g., RGB (red, green and blue) or YUV, as can gray scale imaging. When used in combination with colorimetric sensor arrays and image analysis software, colorimetric differences can be generated by subtracting the RGB values of dye images generated before and after exposure of the dye to a sample, which in this invention is exhaled breath. The colorimetric differences represent hue and intensity profiles for the array in response to analytes present on exhaled breath. This eliminates the need for extensive and expensive signal transduction hardware associated with previous sensor array techniques (e.g., piezoelectric or semiconductor sensors). When used in accordance with the method of the present invention, a unique color change signature can be created which provides the proper diagnosis of positive or negative for lung cancer.

The colorimetric sensor array can furthermore be interfaced to a spectroscopic measurement system. Such a measurement system can divide the electromagnetic spectrum, or portions thereof, into as many as 500 individual bandpass windows whereas a three-color imaging system by definition contains only three such windows. A spectroscopic measurement system is therefore capable of detecting smaller color changes than can be detected by three-color imaging systems, effectively increasing the sensitivity of the entire cross-responsive sensing system. Accordingly, in particular embodiments of the present invention, a spectroscopic measurement system is employed as a visual imaging component. As used herein, spectroscopic measurement systems refer to any system that yields higher color resolution than a three-color imaging system. This can be an imaging spectrograph, fiber optic probe(s) coupled to a spectrograph, or other spectroscopic system.

To provide data analysis, the instant apparatus can be combined with standard chemometric statistical analyses (e.g., principal component analysis (PCA), hierarchal cluster analysis (HCA), and linear discriminant analysis (LDA)), an artificial neural network (ANN), a random forest, or other pattern recognition algorithms to correlate dye color changes to lung cancer status.

In addition, there is extensive classification information in the temporal or kinetic response of individual dyes as they are exposed to exhaled breath. The rate and magnitude of response varies for different chemoresponsive dyes, and the overall pattern of response is different when the subject is positive for lung cancer relative to negative for lung cancer.

These temporal color changes can be analyzed using PCA to provide a diagnosis of positive or negative for lung cancer. PCA determines the number of meaningful, independent dimensions probed by a colorimetric sensor array apparatus of the invention and creates a new coordinate space defined by these dimensions. This space is referred to as “PCA space.” The states of positive and negative for lung cancer are represented by coordinates or ranges of coordinates in PCA space. Vectors from incoming samples, i.e., patient to be diagnosed for lung cancer status, are projected onto this new coordinate space and the distance between the unknown incoming vector and the positive and negative vectors in the training set are calculated. The result is a numerical “probability of classification” as positive or negative for lung cancer. The coordinates in principal component space can also be analyzed using a Bayesian or other classifier to develop a diagnostic metric for lung cancer.

In HCA, the three color channels corresponding to each dye channel can be thought of as vectors in n-dimensional space, where n=3*N (3 color channels per each of N spots). HCA on the composite n-dimensional vectors at either a single time point or “time stacked” over multiple time points partitions the data into clusters. These clusters may correspond to positive or negative for lung cancer.

A third method, LDA, operates on a training set of data to define a new n-dimensional vector space in which the coordinates are selected so as to minimize the distance between matching vectors (same lung cancer status; positive or negative) and maximize the distance between dissimilar vectors (different lung cancer status). Vectors from incoming samples, i.e., undiagnosed patients, are projected onto this new coordinate space and the distance between unknown vector and the known lung cancer status vectors in the training set are calculated. The result is a numerical “probability of classification” as positive or negative for lung cancer.

By way of further illustration, ANN is an information processing system that functions similar to the way the brain and nervous system process information (Tuang, et al. (1999) FEMS Microbiol. Lett. 177: 249-256). The ANN is trained for the analysis and then tested to validate the method. In the training process, the ANN is configured for pattern recognition, data classification, and forecasting. Commercial software programs are available for this type of data analysis.

Yet another method is the random forest, which is a collection of classification trees that stem from bootstrap samples of the data (Breiman (2001) Machine Learn. 45:5-32). A random forest allows for a wider range of relationships to be drawn between the lung cancer state and the response of dye spots within the colorimetric sensor array than do linear models. Random forests also minimize chances of bias in developing classification schemes.

The instant system can employ such methods for the diagnosis of lung cancer by sampling the exhaled breath of a subject with lung cancer, or suspected of having lung cancer, and analyzing the signal generated by a colorimetric sensor array upon exposure to the exhaled breath. Moreover, the instant system can be used to routinely screen for lung cancer, e.g., as part of a regular patient check up.

As will be appreciated by the skilled artisan, the apparatus, system and general steps of the method of the instant invention can be readily modified for use in detecting other analytes or mixtures of analytes in exhaled breath for other medical diagnostic purposes such as assessment of liver or renal function or detection of airway conditions (e.g., asthma), sinus infections (e.g., bacterial or fungal sinusitis), respiratory infections (e.g., pneumonia), and the like. In such assays, the subject may or may not be administered urea or other substrates (e.g., N-alkylamine or other Cytochrome P450 substrate, bronchial dilators) prior to detection of exhaled ammonia or other analyte and may or may not have a baseline reading taken prior to the administration of the substrate. Wherein a baseline reading is not taken, the results of the breath test can be compared to a set of standardized baseline array data or control array data which are indicative of the particular disease being diagnosed.

The invention is described in greater detail by the following non-limiting example.

### EXAMPLE 1

### Lung Cancer Detection

One hundred and forty-three individuals were examined for lung cancer both with conventional diagnostic techniques and by application of a colorimetric sensor array as disclosed herein to analyze exhaled breath. The lung cancer and lung disease status, as determined by conventional diagnostic techniques, of these individuals was listed in Table 1.

TABLE 1

| Disease State | Number |
|---|---|
| Non-Small Cell Carcinoma (NSCCA) | 49 |
| Healthy | 21 |
| Sarcoidosis | 20 |
| Pulmonary Arterial Hypertension (PAH) | 20 |
| Idiopathic Pulmonary Fibrosis (IPF) | 15 |
| Chronic Obstructive Pulmonary Disease COPD | 18 |

Subjects performed tidal breathing for 12 minutes. The breath was pulled over the colorimetric sensor array, which was positioned on a flatbed scanner, at a controlled flow rate by a downstream air pump. The entire system, to include breath capture tubing, was held at physiological temperature. Software was used to drive the scanners, collect images, analyze images, and calculate color change values for each spot on the colorimetric sensor array. Random forest data analysis was used to classify subjects as positive or negative for lung cancer. The training set data included lung cancer diagnosis as determined by conventional techniques. The diagnostic results obtained using the colorimetric sensor array to analyze exhaled breath are listed in Table 2.

TABLE 2

| | Model | Validation | Validation | |
|---|---|---|---|---|
| | Error Rate | Sensitivity | Specificity | |
| | (%) | (%) | (%) | p Value |
| NSCCA | 14.1 | 73.3 | 72.4 | 0.01 |
| Healthy | 6.7 | 57.1 | 78.4 | 0.23 |
| Sarcoidosis | 10.0 | 16.7 | 81.1 | 0.69 |
| PAH | 13.3 | 16.7 | 73.0 | 0.51 |
| IPF | 9.8 | 40.0 | 92.3 | 0.09 |
| COPD | 17.3 | 33.3 | 78.9 | 0.41 |

The colorimetric sensor array achieved a sensitivity of 73.3% and a specificity of 72.4% (p=0.01).

### EXAMPLE 2

### Dye—Analyte Pairs

Table 3 provides a list of dyes, the analytes which the dyes can detect, and the resulting color change.

TABLE 3

| Dye | Analyte | Color Change |
|---|---|---|
| Cresol Red (basic) | Carbon dioxide | Violet -> Yellow |
| Phenol Red (basic) | Carbon dioxide | Red -> Yellow |
| Bromocresol Green | Ammonia | Yellow -> Green |
| | | Yellow -> Blue |
| Reichardt's Dye | Acetic Acid | Blue -> |
| | | Colorless |
| Tetraphenylporphirinato | Ethanol | Green -> Brown |
| manganese (III) chloride | | |
| [MnTPPCl] | | |
| Tetraphenylporphirinato | Pyridine | Red -> Green |
| cobalt (III) chloride | | |
| [CoTPPCl] | | |
| Zinc tetraphenylorphyrin | Methyl amine | Maroon -> Brown |
| [ZnTPP] | | |
| Tetraphenylporphyrin | Hydrogen | Brown -> Green |
| [H₂TPP] | chloride | |
| Tetraphenylporphyrin | Ammonia | Green -> Brown |
| [H₄⁺²TPP] (diprotonated) | | |
| Bismuth (III) | Hydrogen Sulfide | Colorless -> |
| neodecanoate | | Black |
| Tetra(2,6- | Hydrogen Cyanide | Brown -> Green |
| dihydroxy)phenyl | | |
| porphyrin(with HgBr₂) | | |
| Copper(II) | Hydrogen Sulfide | Sky blue -> |
| acetylacetonate | | Brown |
| Copper(II) | Methanethiol | Sky blue -> |
| acetylacetonate | | Brown |
| Palladium(II) acetate | Methanethiol | Light yellow -> |
| | | Dark Yellow |
| Palladium(II) acetate | Hydrogen Sulfide | Light yellow -> |
| | | Brown |
| Zinc | Chlorine | Deep pink -> |
| tetramesitylporphyrin | | Green |
| (ZnTMP) | | |
| Thymol Blue | Triethyl amine | Maroon -> Brown |
| Zinc Tetra(2,6- | Alcohol | Pink -> Sandy |
| difluorophenyl)porphyrin | | brown |

What is claimed is:

1. An apparatus for detecting lung cancer comprising a breath capture device including at least one colorimetric sensor array having a plurality of chemoresponsive dyes deposited thereon in a predetermined pattern combination, wherein at least one of the chemoresponsive dyes is a selected Lewis acid/base dye and wherein, in response to lung cancer analytes in exhaled breath, a distinct and direct spectral, transmission or reflectance response is produced by the dyes.

2. The apparatus of claim 1, further comprising an air flow component to pass a predetermined amount of exhaled breath over the colorimetric sensor array.

3. The apparatus of claim 1, further comprising a component for maintaining the apparatus at physiological temperature.

4. A system comprising the apparatus of claim 1 and a visual imaging component.

5. A method for detecting lung cancer comprising sampling an exhaled breath with the apparatus of claim 1; and detecting the distinct and direct spectral, transmission or reflectance response of the dyes in response to the exhaled breath, wherein the pattern of the response of the dyes is indicative of lung cancer.
